(19) United States
(12) Patent Application Publication
(10) Pub. No.: US 2004/0124598 A1
(43) Pub. Date: Jul. 1, 2004

(54) Grocery cart system

(76) Inventor: Don C. Williams, New Orleans, LA (US)

Correspondence Address: C. EMMETT PUGH, 82 N. MAIN ST., SUFFIELD, CT, 06078-2102, US

(21) Appl. No.: 10/334,617

(22) Filed: Dec. 31, 2002

(51) Int. Cl. B62B 1/04

(52) U.S. Cl. 280/47.29

(57) ABSTRACT

A wheeled, collapsible grocery cart (10) for carrying groceries (20/30) having an operative “L” shaped configuration for transporting bagged groceries suspended on hooks (17/17A) but also collapsible for storage. A series of laterally and longitudinally spaced, protruding, hooks on the “vertical” member (11) located at three (3) height levels, allowing the bagged groceries to be suspended either completely above the base member (12) or with the bottoms of at least some of the loaded grocery bags to be supported on the base member but with their tops suspended up by the hooks. The cart allows a large quantity of bagged and other groceries to be typically in one trip. The cart's small size with bagged groceries often can be placed in the user's vehicle and transported in its “L” shaped configuration, saving time and effort in moving the groceries from the store into the user's home.

### TECHNICAL FIELD

The present invention relates to a load carrying, wheeled cart for carrying, for example, groceries and the like carried in the form of multiple, loaded grocery bags having handles and other grocery load items such as, for example, cases of canned foods, beverages, large sacks, etc, and an associated method of transporting such loaded groceries from, for example, the check-out counter to the user's vehicle and/or from the user's vehicle to the user's home.

### BACKGROUND ART

It is known, for example, to use wheeled carts of various designs to carry many different loads, with such a concept being known for centuries. For example, in more recent times, it is known in other arts, for example, transporting luggage to and from an airport or other travel center, to use relatively light-weight, “L” shaped, collapsible, wheeled carts of telescoping, tubular construction of relatively narrow design.

In the grocery art, it is known, for example, to use grocery shopping carts or buggies designed primarily for a shopper to use in taking selected grocery items from the grocery store racks to the store's check-out counter for bagging in plastic or paper bags at least some of the purchased groceries. Such grocery carts or buggies have at least four wheels, is not “L” shaped and is not collapsible to a smaller, storage size.

It is noted that typically today grocery stores use either plastic bags and/or paper bags having a loaded height of about nineteen (19″) inches with top handles on them for easy carrying of the bags in the hands, with the hands holding the bags by the bag's handles. Even with paper bags with no handles, they are often inserted into the plastic bags with the nested bags then being carried by the plastic bag's handles. Thus, grocery bags now more typically than not include directly or indirectly bag handles.

The prior art grocery cart buggy, after check-out, then is used by some to carry the purchased groceries in, for example, bags loosely supported at their bottoms and possibly at their sides with the bags merely standing up to some extent in the buggy, typically to the purchaser's vehicle. It is noted that the prior art shopping cart buggy, not being collapsible and being owned by the store and not the user, is too large and too heavy and bulky to easily fit in the typical user's car or other typical vehicle. Thus, the unloaded buggy must be and is left at the store for subsequent use by another shopper in the store. When the shopper gets home, with no cart available, the bagged and other groceries must be individually unloaded and carried by hand, typically in multiple trips, into the home.

This is in sharp contrast to the present invention's use of a collapsible grocery cart of much smaller size than the grocery buggy or shopping cart, which collapsible cart is used in an “L” shaped configuration for transporting bagged groceries but then is easily collapsible into a substantially flat configuration for easy storage and placement in the user's vehicle and which “L” shaped cart has a series of laterally and longitudinally spaced, protruding, hook elements on the “vertical” member of the “L” shape located at at least two (2) and preferably at least three (3) different height levels, allowing the handles of the bagged groceries to be easily hooked on the protruding hook elements and the loaded bags to be suspended either completely above the base, horizontal member of the “L” shape or with the bottoms of at least some of the loaded grocery bags to be supported on the base member but with their tops suspended up by the hook elements. Such an innovative cart allows a large quantity of bagged and other groceries to be brought into the home in one trip, certainly less than the number of trips required in a totally hand operation. Also, due to the relatively small size of the invention's cart (as compared to the prior art shopping cart), the cart with at least the bagged groceries often can be placed in the user's vehicle and transported even in its “L” shaped, non-collapsed configuration, saving time and effort in moving the groceries from the vehicle into the user's home.

Other innovative, patentable aspects of the present invention over the prior art are brought out below.

### GENERAL SUMMARY DISCUSSION OF INVENTION

The present invention is directed to a grocery cart transportation system for transporting groceries, including bagged groceries having top handles, over a relatively short distance, for example, from a grocery store check-out counter to a vehicle parked in or near the grocery store's parking lot or from a vehicle parked near the user's home into the user's home, that is, for a matter of about a city block or less.

The present invention's system uses a collapsible grocery cart of much smaller size than the grocery buggy or shopping cart of the prior art, which collapsible cart is used in an “L” shaped configuration for transporting bagged groceries, as well as possibly other, large, non-bagged grocery items, but then is easily collapsible into a substantially flat configuration for easy storage and placement in, for example, a user's car or other vehicle. The “L” shaped cart has a series of laterally and longitudinally spaced, protruding, hook elements on the “vertical” member of the “L” shape cart whith the hook elements located at at least two (2) and preferably at least three (3) different height levels above the bottom, base member of the “L” shape, allowing the handles of the bagged groceries to be easily hooked on the protruding hook elements and the loaded bags to be suspended either completely above the base, horizontal member of the “L” shape or with the bottoms of at least some of the loaded grocery bags to be supported on the base member but with their tops suspended up by the hook elements.

Such an innovative cart allows a large quantity of bagged and other groceries to be brought into the home in one trip, certainly in less than the number of trips required in a totally hand operation. Also, due to the relatively small size of the invention's cart (as compared, for example, to the prior art shopping cart or buggy), the cart with at least the bagged groceries often can be placed in the user's vehicle and transported even in its “L” shaped, non-collapsed configuration, saving time and effort in moving the groceries from grocery store in the vehicle and then into the user's home or other desired location or final destination.

Between uses the unique cart of the present invention can be collapsed into a very small configuration for, for example, easy compact storage in the user's vehicle or elsewhere, awaiting the next trip to the grocery store in which a substantial amount of groceries are bought, typically and ultimately involving a number of loaded grocery bags and a number of large, non-bagged grocery items, with the latter being placed on the base member of the cart.

It is also noted that the preferred cart used in the present invention has a significantly wider stance or wheel separation distance than the comparable carts used in other non-analogous art areas.

There are, of course, many other possible applications, methods, structures and variations for the inventive concepts of the present invention, but the foregoing, particular ones are currently believed to be especially efficacious and innovative ones.

### BRIEF DESCRIPTION OF DRAWINGS

For a further understanding of the nature and objects of the present invention, reference should be had to the following detailed description, taken in conjunction with the accompanying drawings, wherein:

FIG. 1 is a perspective, front view of an exemplary, currently preferred embodiment of the grocery cart used in the exemplary, currently preferred embodiment of the grocery cart system of the present invention, holding, for example, an exemplary bag of groceries with the exemplary bag having handles for easy hanging from the hook(s) of the cart and the bottom of the bag resting on the base member of the cart.

FIG. 2 is a side view of the exemplary embodiment of FIG. 1, with the other side being a mirror image thereof.

FIG. 3 is a side, detail view of an alternative, exemplary, elongated, hook element (17A) for use as an alternative to the hook, attachment element (17) of FIGS. 1 & 2.

### EXEMPLARY MODES FOR CARRYING OUT THE INVENTION

### Listing of Reference Numbers

For ease of reference to the drawings, the drawing reference numbers are listed below.

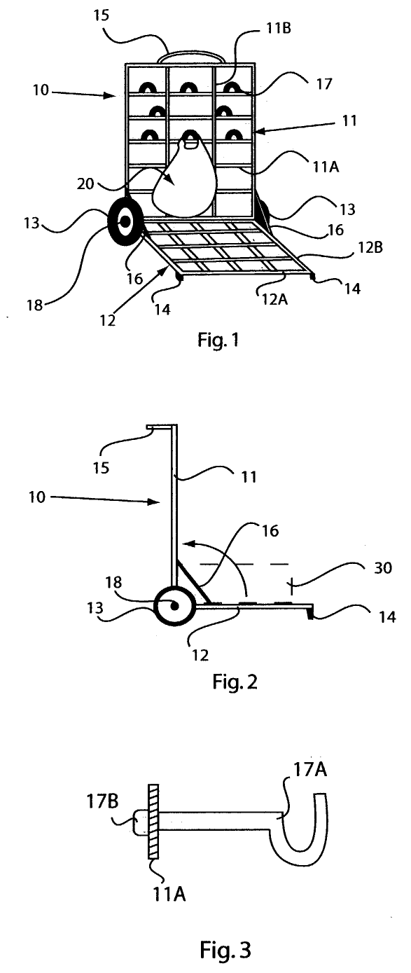

FIGS. 1 and/or 2—

10 exemplary grocery cart

11 top/back part of cart

11A lateral members making up part of the top/back part

11B longitudinal members making up part of the top/back part

12 bottom part of cart

12A lateral members making up part of the bottom part

12B longitudinal members making up part of the bottom part

13 rotatable wheels

14 static feet

15 handle

16 structural bracing

17 grocery bag hook elements

18 pivot axis & axle

20 exemplary grocery bag suspended from a hook

30 exemplary box of groceries

FIG. 3—

11A lateral members making up part of the top/back part

17A orthogonally extended hook element

17B hook element securing nut

### Exemplary Cart 10 of FIGS. 1 & 2

As can be seen in FIGS. 1 & 2, the currently preferred, exemplary embodiment of the grocery cart 10 useable in the currently preferred, exemplary system of the present invention includes an exemplary tubular structure including a back/top, “vertical” part 11 made up of a series of lateral, flat plates or other form of structural members 11A and a series of orthogonal, longitudinal tubes or other form of structural members 11B, the combination forming a lattice work of strong but light weight structural members, and a like base or bottom part 12, made up of a series of lateral plates or other form of structural members 12A and a series of orthogonal, longitudinal tubes or other form of structural members 12B, the combination forming a strong but light weight lattice work of structural members.

In operation the base or bottom portion 12 of the cart 10 is positioned and latched horizontally above the “ground,” making an exemplary angle of ninety (90°) degrees with the top/back portion 11. However, as indicated by the curved directional arrow in FIG. 2, the base portion 12 can be folded up to be essentially parallel to the back portion 11 for compact, collapsed storage between grocery carrying uses.

Thus, as can be seen in FIGS. 1 & 2, the exemplary, preferred embodiment 10 of the grocery cart of the present invention includes a “vertical,” rectangular, back member 11 and a rectangular, horizontal base or bottom member 12 which are pivotally attached together at their joined attachment edges. As indicated by the curved arrow in FIG. 2, the back member 11 and the base member 12 can be relatively moved toward each other about the pivot axis 18 between an erected “L” shaped disposition, as illustrated, for, for example, transporting groceries, to a face-to-face, essentially parallel, compact, collapsed disposition for, for example, storage between operative uses.

The back member 11 is made up of, for example, a series of spaced, laterally extending bars, tubes and/or slats 11A and a series of crossing, longitudinally extended bars, tubes and/or slats 11B. Likewise, the base member 12 is made up of a series of spaced, laterally extended bars, tubes and/or slats 12A and a series of crossing, longitudinally extended bars, tubes and/or slats 12B. This produces strong members which over-all are light weight but with the strength to carry the grocery and like objects for which it is designed.

A pair of front, support feet 14 are included at the bottom of the leading edge of the base member 12 for preferably horizontal support of the base member above the ground. When in the disposition illustrated in FIGS. 1 & 2, the base member 12 serves as a convenient platform for holding and transporting relatively large objects 30, such as, for example, cases of soft drinks, multiple canned products, boxed products in general, large sacks of fungible items (e.g., a twenty-five pound sack of dog food), and the like. The footing produced by the feet 14 can either be provided by separate, connected elements, as illustrated, or be integrally formed by, for example, appropriately folding the tubing used along the peripheral edges of the side and front edge of the base, bottom member 12.

A handle 15 is included at the top of the back member 11 to better manipulate the cart when, for example, moving it around for transport of the grocery items the cart is carrying from one location (e.g., the grocery or supermarket check-out counter) to another location (e.g., the user's vehicle), or, for further example, from the user's vehicle into the user's home.

A pair of freely rotatable, side wheels 13, which are the only wheels on the cart 10, are mounted on the axle 18 for easy movement of the cart 10 over the ground. The user merely pulls back on the handle 15, moving the support feet 14 up off the ground, and then guides or otherwise manipulates the cart and moves it over the ground on the wheels 13. The wheels 13 preferably have a relatively large diameter which allows the cart 10 to be more easily moved up or down from curbs and th like.

The handle 15 can either be fixed to the back member 11, as illustrated, or attached with a telescoping arrangement providing, alternatively, a higher placed handle during use and a more compact form for storage, with the handle telescoped in to the back member.

Support or temporary attachment, hook elements 17 are spaced from one another, preferably laterally as well as vertically spaced, and located about different parts of the back member 11 to which various items, for example, grocery bags 20 whose handles are draped or hooked over the attachment elements 17, are supported up on the back member, preferably a number of them above the base member 12, with the lower ones of the attachment elements preferably allowing the bottom of their respective bag(s) 20 to rest their bottom(s) on the upper surfaces formed by the base member 11, while those suspended on the upper level(s) [three exemplary levels being illustrated] of the attachment elements 17 have their bag bottoms supported above the base member. This varying, “vertical” levels of the attachment elements 17, there being at least two (2) and preferably at least three (3) or more, is an important, independent aspect of the present invention, allowing the bag bottoms to be at least either supported by the base member 12 or supported above the base member, as may be desired. Additionally, having at least three (3) levels of attachment elements 17, as illustrated, allow different length bags to be supported with their bottoms likewise either supported by the base member 12 or supported above the base member, as may be desired

The attachment elements 17 allow the grocery bags 20 to be quickly and easily placed on the back member 11 for transportation. The attachment elements can be, for example, inverse “U” shaped, as illustrated, or basically be of any extended or protruded configuration which allows the grocery bag handles to be easily placed over it and securely held in place during transportation. Also, as an alternative to the static attachment elements 17 (17A) illustrated, they could be dynamic being in the form of active clasps or clamps or the like, if so desired. However, it is noted that typically passive or static attachment elements are not as subject to breaking or damage as dynamic ones having moving parts, and also are less expensive to produce.

An alternative, passive structure and design for the bag attachment elements is a forwardly or outwardly, orthogonally extended, hook member 17A illustrated in FIG. 3. The hook member 17A is attached to its respective lateral bar 11A by means of, for example, a threaded nut 17B, threadingly interfaced with the like threaded, proximal end of the hook member. The orthogonally extended hook member 17A allows for a very secure attachment for the grocery bag handles into the crook or curve of the hook. The extended shaft of the hook member 17A can be made of any appropriate, desired length, as long as it is extended a sufficient length to allow the easy engagement of the handle of the bag(s) 20, preferably into the crook of its hook end.

If so desired, the attachment or hook elements 17 (17A) can be located at the intersections of the crossing members 11A & 11B for added structural strength, rather than merely being attached to the laterally extended bars 11A, as illustrated.

Thus, another, special, independent aspect of the present invention is the use of a collapsible cart 10 that includes a back member with a series of laterally and longitudinally spaced hook members for securely but temporarily holding and supporting a series of likewise spaced bags of groceries having handles at their upper ends, with some of them being supportable at their bottoms on the base or bottom member 12 and some raised above it, that is, the bottom of the grocery laden bags do not touch the bottom member 12 but are suspended above it.

Hence, a user of the cart 10, when located at, for example, a grocery check-out counter, merely positions the cart in its latched, “L” shaped configuration and places the bags of groceries on selected ones of the attachment elements 17 (17A) with any unbagged boxes, cases and other, relatively large, rigid packages 30 of goods placed on the top of the base member 12. After completely loading the cart 10, the user merely grabs the handle 15 and moves and guides the loaded cart on its wheels 13 to, for example, the user's vehicle and loads the groceries into the vehicle for transportation home. If the interior of the vehicle provides sufficient vertical clearance and the loaded cart is not too heavy for the user, the cart 10, while in its “L” shaped disposition and with at least its loaded bags 20 on the attachment elements 17 (17A), is picked up and placed in the vehicle without removing the grocery bags. This makes off-loading that much easier and quicker when the user arrives home and then needs to move the groceries into the home or other desired location, eliminating the need for separately unloading the groceries from the cart into the vehicle at the grocery store end and re-loading the cart from the vehicle at the home end.

Thus, another, special, independent aspect of the present invention includes the method of placing a number of loaded groceries bags 20 having handles onto the back member using a series of spaced, handle hook support elements 17 (17A) with the loaded cart 10 placed into and inside a vehicle for further transportation while the cart is in its “L” shaped configuration or disposition.

When the transportation of the bagged groceries is completed, the cart 10 is then moved into its face-to-face, collapsed disposition and placed in storage in, for example, the user's vehicle, awaiting the need for its next grocery transportation use.

Exemplary dimensions, subject to reasonable variation, for the exemplary cart 10 are outlined below:

| Element/Member | Dimensions in Inches |
|---|---|
| Dimensions of Back Member 11 | About 38 (high; with handle fully |
| with Handle 15 | extended up) × 20 wide |
| Dimensions of Bottom Member 12 | About 12 (deep) × 20 (wide) |
| Diameter of Wheels 13 | About seven (7) |
| Height of Lowest Level of Hook | About eighteen (18) above base, |
| Elements 17 (17A) | bottom member 12 |
| Height of Mid-Level of Hook | At least about four (4) above lowest |
| Elements 17 (17A) | level of attachment hooks |
| Height of Third-Level of Hook | At least about four (4) above |
| Elements 17 (17A) | preceding level of attachment hooks |
| Separation Distance of Wheels 13 | About twenty (20) |

It is noted that the about twenty (20″) inch separation distance between the wheels 13 is significantly greater than the typical twelve (12″) inch separation distance found on tubular luggage carts and the like sold for transporting non-analogous suitcases and the like to and from an airport or other transportation center, etc, an art area different from the bagged groceries transportation field of the present invention, with transports relatively small, relatively light-weight, non-rigid, loaded bags having a length of about nineteen (19″) inches, typically carrying a number of loose items being easily moveable relative to one another in the flexible bag.

The back and base members 11 & 12 can be made of metal, for example, chromed, aluminum tubes along their edges with flat pieces welded to it and to each other at their respective crossing areas, or other material and structural design providing the structural strength needed for the grocery carrying function of the cart and preferably of relatively low weight for convenience in handling and hand carrying, for example, the collapsed cart 10 above the ground, that is, not supported at all on the ground.

If so desired, one or more elastic or “bungee” cords with hooks at their ends can be used with the cart 10 for further securing the loaded grocery bags 20 to the back member 11 and/or the large, unbagged items 30 to the base and/or back member(s) 12/11 of the cart.

It should be understood that the term “grocery” as used herein includes not only classical grocery stores but also supermarkets, wholesale or warehouse stores, etc., that is, anywhere groceries or like bagged items can be purchased on-site by a consumer or associated person and which need to be transported by the person buying or otherwise obtaining the goods. Also, the word “vertical” member refers to a member that at some times during its operative use extends at least generally vertically to the ground, although at other times it may and typically is at some other angle, for example, parallel, to the ground when the cart is in its flat, horizontal, non-operative, storage disposition. Likewise, the word “horizontal” member refers to a member that at some times during its operative use extends at least generally horizontally to the ground, although at other times it may and sometimes is at some other angle, for example, even vertical to the ground when in, for example, a vertical, collapsed, non-operative, storage disposition.

It also should be understood that the foregoing variations and alternatives, etc., described above are merely exemplary and many other changes to the exemplary embodiments are possible within the teachings of the present invention.

Thus, the exemplary embodiment of the present invention described herein in detail for exemplary purposes is of course subject to many different variations in structure, design, application, materials and methodology. Because many varying and different embodiments may be made within the scope of the inventive concept(s) herein taught, and because many modifications may be made in the embodiment herein detailed in accordance with the descriptive requirements of the law, it is to be understood that the details herein generally are to be interpreted as illustrative and not in a limiting sense.

What is claimed is:

1. A method of moving groceries after purchase, which groceries items include at least multiple bags of groceries, each bag having top handles, comprising the steps of:
a) using a collapsible, wheeled grocery cart having only two, laterally spaced wheels and an “L” shaped configuration, formed by a back, vertical member and a bottom, horizontal member, with a top handle for transporting at least some bagged groceries but then is easily collapsible into a substantially flat configuration for easy storage by bringing the back member and the bottom member together in face-to-face, essentially parallel positions, with the “L” shaped cart having a series of laterally and longitudinally spaced, protruding, hook elements on the “vertical” member of the “L” shape located at at least two (2) different height levels above the bottom, “horizontal” member, allowing the handles of the bagged groceries to be easily hooked on selected ones of the protruding hook elements with the loaded bags to be suspended either completely above the bottom, horizontal member of the “L” shape using the hook elements at a higher height level or with the bottoms of at least some of the loaded grocery bags to be supported on the bottom member using the hook elements at a lower height level, but with their tops suspended up by the bags' respective hook elements;
b) placing bagged grocery items on the “L” shaped cart by hooking the handles of the bags on selected appropriate ones of the hook elements;
c) thereafter rolling the loaded cart on its wheels using the handle to manipulate the loaded cart moving it with its load of groceries from the check-out counter to the user's vehicle;
d) thereafter placing the cart and the groceries into the vehicle and driving the vehicle to a desired, final location, with the cart and groceries in it, moving the groceries to the desired, final location; and
e) thereafter using the cart to move the groceries into the desired, final location with the bagged groceries hanging from selected ones of the hook elements.

2. The method of claim 1, wherein the cart has at least three (3) different height levels and the loaded bags are of two different heights, a taller height bag and a lower height bag; and wherein in the step “b” there is further included the step of:
b-1) using at least the third, height level of hook elements to support at least some of the taller level bags and at least one of the other two level height hook elements for at least some of the lower height bags.

3. The method of claim 1, wherein after step “e” there is included the steps of:
f) collapsing the cart into its compact, non-operative, storage disposition and storing the collapsed cart in the user's vehicle, awaiting its next grocery transporting use.

4. The method of claim 1, wherein steps “d” are performed with the steps of:
placing the cart and at least the loaded bagged groceries together into the vehicle while the cart is in its “L” shaped disposition and driving the vehicle to a desired, final location while the cart is in its “L” shaped disposition with at least the loaded bagged groceries suspended from the hook element, moving the groceries to the desired, final location.

5. The method of claim 1, wherein in step “b” there is also included the step of:
b-1) also placing large, non-bagged grocery items on the bottom, horizontal member for transport of the large items ultimately to the desired, final location.

6. A grocery cart transportation system for transporting groceries, including bagged groceries having top handles, over a relatively short distance, for example, from a grocery check-out counter to a vehicle parked near the grocery store or from a vehicle to the user's home or other desired, final destination, that is, for a matter of about a city block or less, comprising:
a wheeled cart having a back, “vertical” member and a bottom, “horizontal” member attached together for pivoted movement between an “L” shaped, operative disposition and a relatively flat, face-to-face, compact, essentially parallel, non-operative, storage disposition; and
a series of bag handle hook elements laterally and longitudinally spaced at least in part from one another located at different height levels above the bottom member and about the back member for receiving and holding the handles of the grocery bags on the handle hook elements while being transported on said cart, at least some of said hook elements being spaced above the attachment between said members the full length of the grocery bag, allowing the grocery bags being supported thereon to be held with their bottoms above said bottom member when said cart is in its “L” shaped disposition.

7. The system of claim 6, wherein there are:
at least three height levels of said hook elements, the lowest height level of which allows the tops of the loaded grocery bags to be suspended up from this height level of hook element while their bottoms rest on said bottom member.

8. The system of claim 6, wherein:
said back and said bottom members have a width of about twenty (20″) inches.

9. The system of claim 6, wherein:
said cart has only two wheels, said wheels having a separation distance Of about twenty (20″) inches.
